(19) United States
(12) Patent Application Publication
(10) Pub. No.: US 2024/0407303 A1
(43) Pub. Date: Dec. 12, 2024

(54) PRUNING SHEARS

(71) Applicant: Milwaukee Electric Tool Corporation, Brookfield, WI (US)

(72) Inventors: Alexander Czubek, Brookfield, WI (US); Alexander Steinhauer, Menomonee Falls, WI (US); John S. Dey, New York, NY (US); Brian Cornell, West Allis, WI (US); Scott A. Libert, Waukesha, WI (US)

(21) Appl. No.: 18/736,669

(22) Filed: Jun. 7, 2024

Related U.S. Application Data
(60) Provisional application No. 63/507,190, filed on Jun. 9, 2023.

(51) Int. Cl. A01G 3/037

(52) U.S. Cl. CPC A01G 3/037

(57) ABSTRACT

Pruning shears including a housing including a motor portion; a handle portion; a motor disposed within the motor portion of the housing; a motor control unit operably coupled to the motor; and a trigger assembly disposed within the handle portion and operably coupled to the motor control unit to control the motor, wherein the trigger assembly includes a trigger; a primary trigger movement detector; and a redundant trigger movement detector, wherein the primary trigger movement detector and the redundant trigger movement detector each sense movement of the trigger when the trigger is pressed and send signals to the motor control unit to control operation of the motor.

### FIELD

The present disclosure relates to a landscaping tools, and more particularly to battery powered pruning shears.

### BACKGROUND

Maintaining a property may require a significant amount of landscaping. Landscaping includes mowing lawns, edging, trimming weeds, trimming bushes, trimming trees, etc. To accomplish these various tasks, a variety of tools may be utilized.

### SUMMARY

In an embodiment of the present disclosure, pruning shears are disclosed and include a housing comprising a motor portion and a handle portion, a motor disposed within the motor portion of the housing, a motor control unit operably coupled to the motor, and a trigger assembly disposed within the handle portion and operably coupled to the motor control unit to control the motor, wherein the trigger assembly includes a trigger, a primary trigger movement detector, and a redundant trigger movement detector, wherein the primary trigger movement detector and the redundant trigger movement detector each sense movement of the trigger when the trigger is pressed and send signals to the motor control unit to control operation of the motor.

In another embodiment of the present disclosure, a method of operating pruning shears is disclosed and includes receiving a primary signal from a primary trigger movement detector, receiving a redundant signal from a redundant trigger movement detector, determining a noise associated with the primary signal, the redundant signal, or a combination thereof, and at least partially based on the noise, preventing the operation of a motor.

In yet another embodiment of the present disclosure, pruning shears are disclosed and include a housing comprising a motor portion, a handle portion, a motor disposed within the motor portion of the housing, a trigger assembly disposed within the handle portion and operably coupled to the motor, wherein the trigger assembly includes a trigger, a trigger potentiometer coupled to the trigger, a magnet disposed on the trigger, and a trigger hall board adjacent the magnet, and a motor control unit operably coupled to the motor and the trigger assembly, wherein the motor control unit is operable to receive at least one trigger potentiometer voltage signal, receive at least one trigger hall sensor voltage signal, and at least partially based on the at least one trigger potentiometer voltage signal and the at least one trigger hall sensor voltage signal, operating the motor.

Other features and aspects of the disclosure will become apparent by consideration of the following detailed description and accompanying drawings.

### BRIEF DESCRIPTION OF THE DRAWINGS

FIG. 1 is a perspective view of pruning shears in accordance with an embodiment of the present disclosure.

FIG. 2 is a left side view of the pruning shears with the blades in a first maximum open position in accordance with an embodiment of the present disclosure.

FIG. 3 is a left side view of the pruning shears with the blades in a second maximum open position in accordance with an embodiment of the present disclosure.

FIG. 4 is a right side view of the pruning shears in accordance with an embodiment of the present disclosure.

FIG. 5 is a top view of the pruning shears in accordance with an embodiment of the present disclosure.

FIG. 6 is a front view of the pruning shears in accordance with an embodiment of the present disclosure.

FIG. 7 is a left side view of the pruning shears in accordance with an embodiment of the present disclosure with a portion of the housing removed.

FIG. 8 is a partial left side view of the pruning shears in accordance with an embodiment of the present disclosure with a portion of the housing removed.

FIG. 9 is a partial top view of the pruning shears in accordance with an embodiment of the present disclosure with a portion of the housing removed.

FIG. 10 is a partial top view of pruning shears in accordance with an embodiment of the present disclosure showing an electromechanical mode selector.

FIG. 11 is a partial left side view of the pruning shears in accordance with an embodiment of the present disclosure with a portion of the housing removed to show details of the electromechanical mode selector.

FIG. 12 is a partial right side view of pruning shears in accordance with an embodiment of the present disclosure showing a blade assembly.

FIG. 13 is a partial right side view of the pruning shears with the upper blade of the blade assembly detached from the pruning shears in accordance with an embodiment of the present disclosure.

FIG. 14 is a left side view of pruning shears in accordance with another embodiment of the present disclosure.

FIG. 15 is a first right side view of pruning shears in accordance with yet another embodiment of the present disclosure.

FIG. 16 is a second right side view of the pruning shears in accordance with yet another embodiment of the present disclosure.

FIG. 17 is a left side view of pruning shears in accordance with still another embodiment of the present disclosure.

FIG. 18 is a schematic diagram of a control system for pruning shears in accordance with an embodiment of the present disclosure.

FIG. 19 is a flow chart illustrating a method of operating pruning shears in accordance with an embodiment of the present disclosure.

FIGS. 20-21 are a flow chart illustrating a method of detecting trigger noise for pruning shears in accordance with an embodiment of the present disclosure.

FIG. 22 is a flow chart illustrating a method of initializing variables for trigger noise detection in accordance with an embodiment of the present disclosure.

Before any embodiments of the present disclosure are explained in detail, it is to be understood that the embodiments described herein are not limited in scope or application to the details of construction and the arrangement of components set forth in the following description or as illustrated in the following drawings. The devices described herein are capable of other embodiments and of being practiced or of being carried out in various ways. Also, it is to be understood that the phraseology and terminology used herein is for the purpose of description and should not be regarded as limiting.

### DETAILED DESCRIPTION

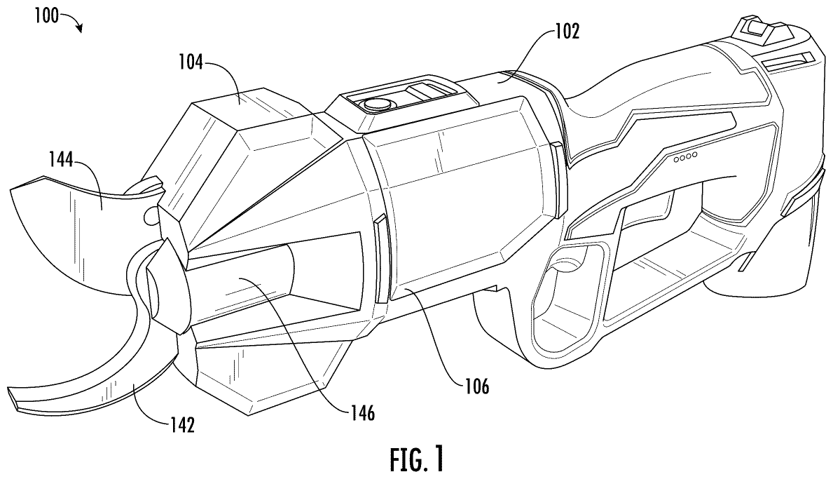

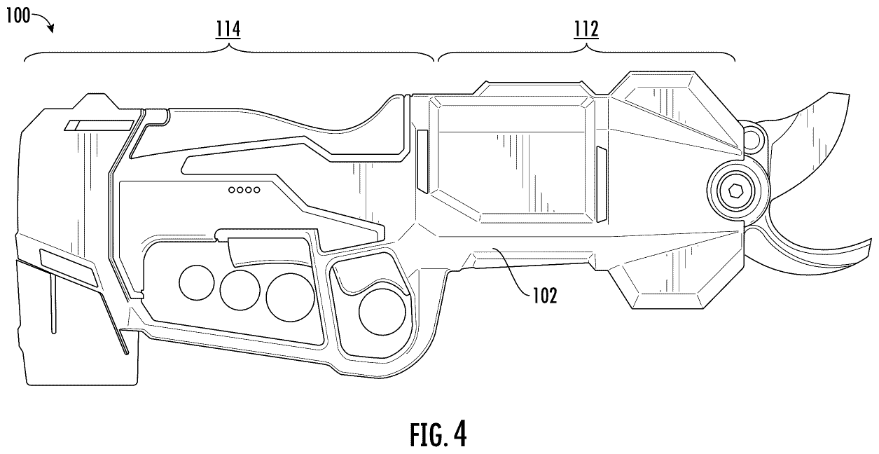

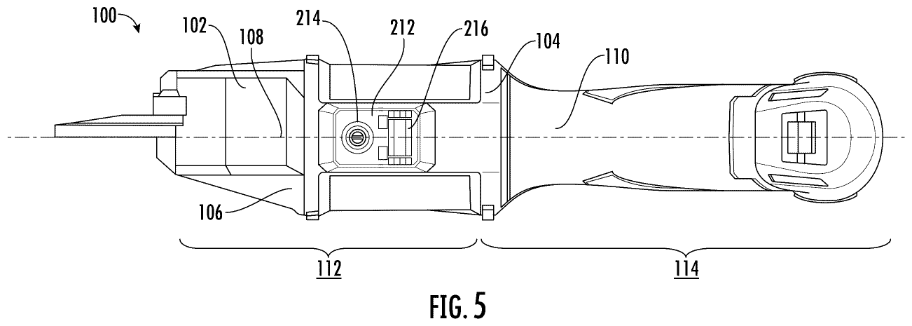

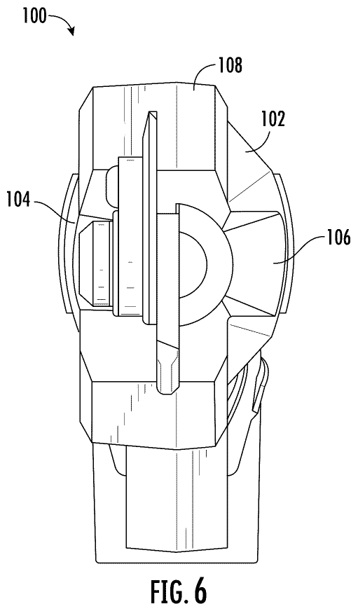

Referring to FIG. 1 through FIG. 6, pruning shears are illustrated and are generally designated 100. As illustrated, the pruning shears 100 include a housing 102 that includes a first housing side 104 and a second housing side 106. As best shown in FIG. 5, the housing sides 104, 106 meet to form an interface 108 along a longitudinal axis 110. It is to be understood that the housing sides 104, 106 are attached, or otherwise affixed, to each other via a plurality of fasteners, e.g., screws, that are not shown in the figures. Alternatively, the housing sides 104, 106 are affixed to each other via an adhesive or via a plastic welding operation.

FIG. 1 through FIG. 7 indicate that the housing 102 defines a motor portion 112 and a handle portion 114. The motor portion 112 includes a motor 120 that has a rotating drive shaft 122. A fan rotor 124 is disposed on the drive shaft 122 and rotates with the drive shaft 122. Further, a gear box 126 is operatively coupled to the drive shaft 122 and includes an output shaft 128. As shown, a pinion gear 130 is disposed on, or operatively coupled, to the output shaft 122 of the gear box 126. In a particular embodiment, the pinion gear 130 is a bevel pinion gear and is generally frustoconical shaped. Further, the pinion gear 130 is a spiral bevel pinion gear.

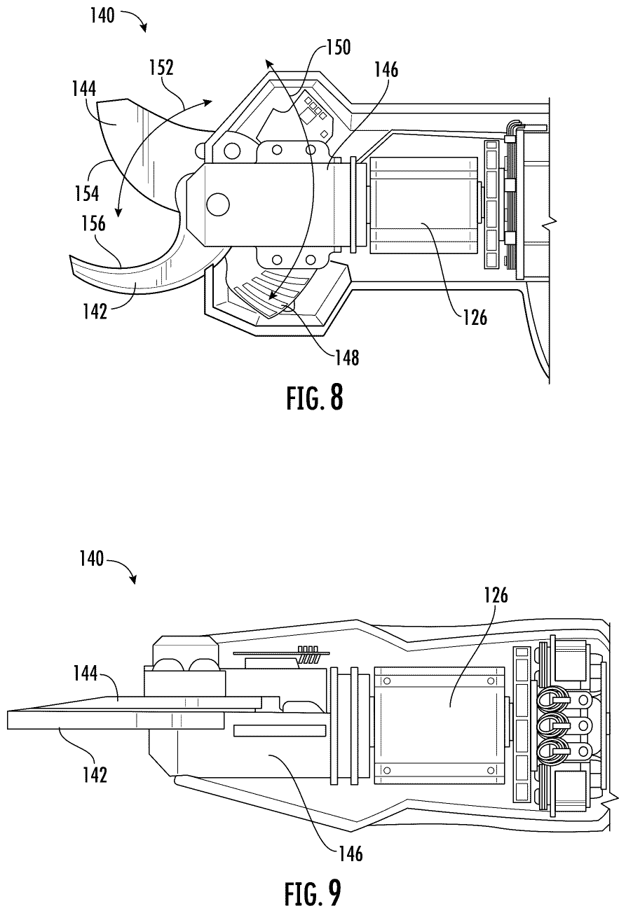

As best illustrated in FIG. 8 and FIG. 9, a blade assembly 140 extends, at least partially, from the motor portion 112 of the housing 102 so that it is at least partially external to the housing 102. In other words, the pruning shears 102 include a blade assembly 140 that extends from the housing 102. The blade assembly 140 includes a support blade 142 and a cutting blade 144 adjacent to the support blade 142. The pruning shears 100 further include a frame 146 that is statically mounted within the housing 102 of the pruning shears 100. As depicted in FIG. 1 through FIG. 3, the frame 146 partially extends from the housing 102 of the pruning shears 100. The support blade 142 is mounted on the frame 146 and the support blade 142 and the frame 146 are stationary and do not move with respect to the housing 102. The cutting blade 144 is operably coupled, or affixed, to an arcuate rack gear 148. In an embodiment, the arcuate rack gear 148 is a spiral arcuate rack gear. The arcuate rack gear 148 is engaged with the pinion gear 130 and as the pinion gear 130 rotates clockwise and counterclockwise, the arcuate rack gear 148 moves back-and-forth along a curved path indicated by curved arrow 150. Moreover, as the arcuate rack gear 148 moves back-and-forth along the path indicated by curved arrow 150, the cutting blade 144, affixed to the arcuate rack gear 148, moves back-and-forth along the path indicate by curved arrow 152. In particular, the cutting blade 144 moves back-and-forth along the path indicated by arrow 152 and in doing so, moves towards and away from the support blade 142.

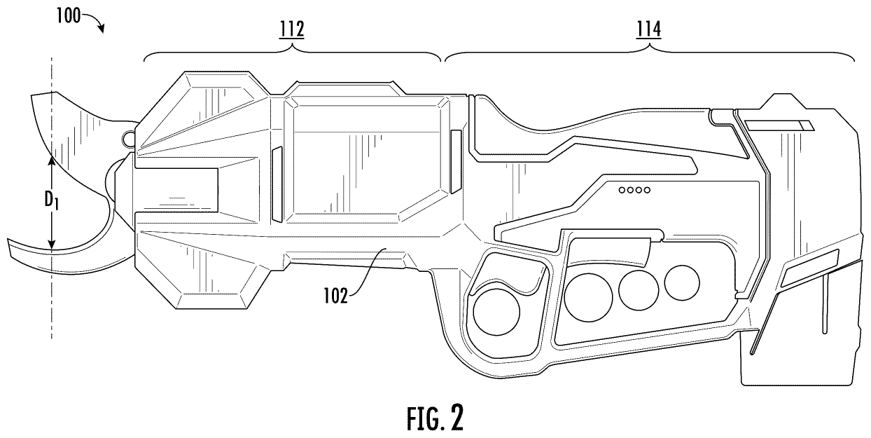

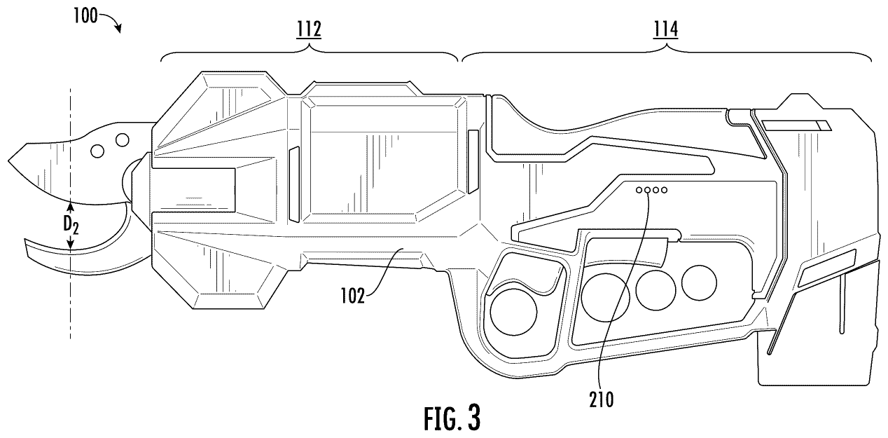

During use, the cutting blade 144 reciprocates from a maximum open position to a closed position relative to the support blade 142. In the maximum open position, a cutting edge 154 of the cutting blade 144 is spaced a maximum distance from a cutting edge 156 of the support blade 142. Conversely, in the closed position, the cutting edge 154 of the cutting blade 144 moves slightly past the cutting edge 156 of the support blade 142. It is to be understood that the blade assembly 140 of the pruning shears 100 can have a first maximum open position, depicted in FIG. 2, and a second maximum open position, depicted in FIG. 3. In the first maximum open position, the blade assembly 140 of the pruning shears 100 defines, or includes, a first maximum open distance, D₁, measured along a vertical axis 158 passing through the lowest point of the cutting edge 156 of the support blade 142 between the cutting edge 154 of the cutting blade 144 and the cutting edge 156 of the support blade 142. Moreover, in the second maximum open position, the blade assembly 140 of the pruning shears 100 defines, or includes a second maximum open distance, D₂, measured along the vertical axis 158 passing through the lowest point of the cutting edge 156 of the support blade 142 between the cutting edge 154 of the cutting blade 144 and the cutting edge 156 of the support blade 142.

As illustrated in FIG. 2 and FIG. 3, D₁ is greater than D₂. Moreover, in first maximum open position, the pruning shears 100 include a first cutting speed, S₁, and in the second maximum open position, the pruning shears 100 include a second cutting speed, S₂. In a particular embodiment, S₁ is less than, or slower than, S₂. The different maximum open positions and different speeds allow the pruning shears 100 efficiently cut branches of a certain size. For example, for larger branches the pruning shears 100 may be switched to the first cutting speed, S₁, i.e., the slower operational speed, and the first maximum open distance, D₁, i.e., the larger maximum open distance. This configuration of the larger maximum open distance and the slower speed allows the pruning shears 100 to be used to cut larger branches while maximizing efficiency and battery life. When cutting smaller branches, the pruning shears may be switched to the second cutting speed, S₂, i.e., the faster operation speed, and the second maximum distance, D₂, i.e., the smaller maximum open distance. This configuration of the smaller maximum open distance and the faster speed allows the pruning shears 100 to be used to cut smaller branches while also maximizing efficiency and battery life.

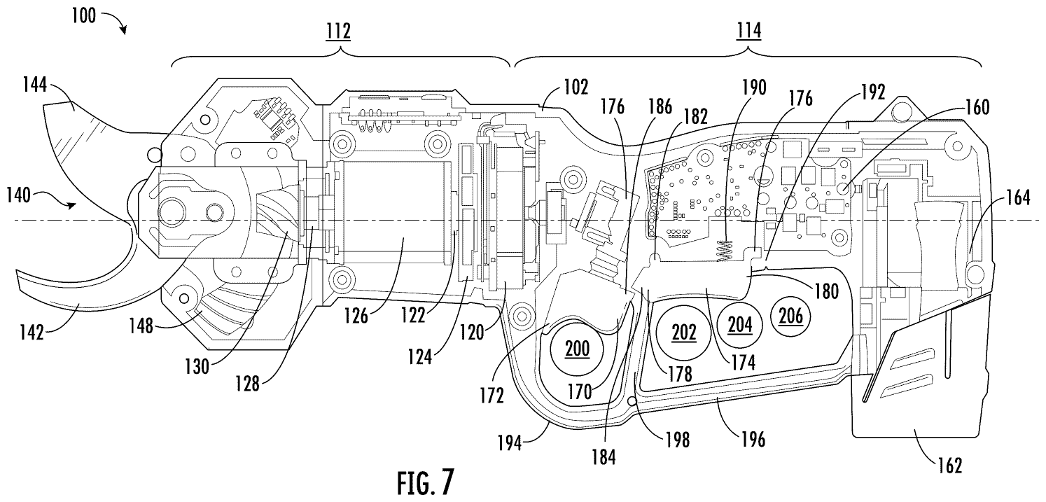

Referring back to FIG. 7, the handle portion 114 of the housing 102 includes a printed circuit board (PCB) 160 therein. The PCB 160 is operably coupled to a battery 162 that is removably engaged with a battery compartment 164 that is formed within the handle portion 114 of the housing 102. The PCB 160 is also operably coupled to the motor 120 within the motor portion 112 of the housing 102 and a trigger assembly 170 that is at least partially disposed within the handle portion 114 of the housing 102.

As shown in FIG. 7, the trigger assembly 170 includes a trigger 172 and a trigger lock 174. When unlocked, the trigger 172 slides linearly relative to the housing 102 in order to depress and release a switch 176 that is operably connected to the motor 120. The trigger lock 174 prevents the trigger 172 from moving relative to the housing 102 until the trigger lock 174 is depressed and the trigger 172 is released. As shown, the trigger lock 174 defines a proximal end 178 and a distal end 180. The proximal end 178 of the trigger lock 174 includes a pivot 182 and a detent 184. When the trigger lock 174 is in the locked position, the detent 184 engages an inner surface 186 of the trigger 172 to prevent movement of the trigger 172. The trigger lock 174 also includes a trigger lock stop 188 that extends from the distal end 180 of the trigger lock 174.

In a particular embodiment, the trigger lock stop 188 prevents the trigger lock 174 from rotating out of the handle 106 portion of the housing 102. A spring 190 is installed within the handle portion 114 of the housing 102 adjacent to the distal end 180 of the trigger lock 174 in order to bias the trigger lock 174 to the locked position in which the detent 178 engages the trigger 172 and the trigger lock stop 190 is against an inner wall 192 of the handle portion 114 of the housing 102. It is to be understood that the trigger lock 174 rotates about the pivot 182 between a locked position in which the detent 184 engages the trigger 172 and prevents movement of the trigger 172 relative to the housing 102 and an unlocked position in which the detent 184 rotates away from the trigger 172, disengages the trigger 172, and allows movement of the trigger 172.

As further illustrated in FIG. 7, the handle portion 114 of the housing 102 includes a trigger guard 194 that extends at least partially around the trigger 172, i.e., the portion of the trigger 172 that extends outwardly, or externally, from the handle portion 114 of the housing 102. Further, the handle portion 114 of the housing 102 includes a trigger lock guard 196 that extends at least partially around the trigger lock 174, i.e., the portion of the trigger lock 174 that extends outwardly, or externally, from the handle portion 114 of the housing 102. As shown in FIG. 7, the trigger guard 194 is separate from the trigger lock guard 196 and a divider 198 extends between the trigger guard 194 and the trigger lock guard 196. In a particular embodiment, the trigger guard 194 is sized and shaped to receive an index finger 200 of a user. Moreover, the trigger lock guard 196 is sized and shaped to receive a middle finger 202, a ring finger 204, and a pinky finger 206 of the use. Thus, during operation, a user can grip the pruning shears 100 around the handle portion 114 of the housing 102 and can use one or more of the middle finger 202, ring finger 204, and pink finger 206 to actuate the trigger lock 74 and release the trigger 172. At the same time, a user can use the index finger 200 to actuate the trigger 172 while the trigger lock 174 is in the unlocked position.

Referring briefly to FIG. 3, the pruning shears 100 further include a batter level indicator 210. The battery level indicator 210 can include a series of light emitting diodes (LEDs) or other lights that indicate the level of battery remaining based on a number of LEDs lit. For example, when a battery level is at maximum all of the LEDs of the battery level indicator 210 are lit. As the battery level decreases, the number of LEDs of the battery level indicator 210 that are lit may decrease. FIG. 5 indicates that the pruning shears 100 also includes a user interface 212 disposed on a top of the housing 102. The user interface 212 includes a display 214 that indicates the current power state (on or off) and the current operation mode of the pruning shears 100. The user interface 212 also includes a switch 216 that is used to switch between the operation modes provided by the pruning shears 100, e.g., different speeds and different maximum open positions, as described above.

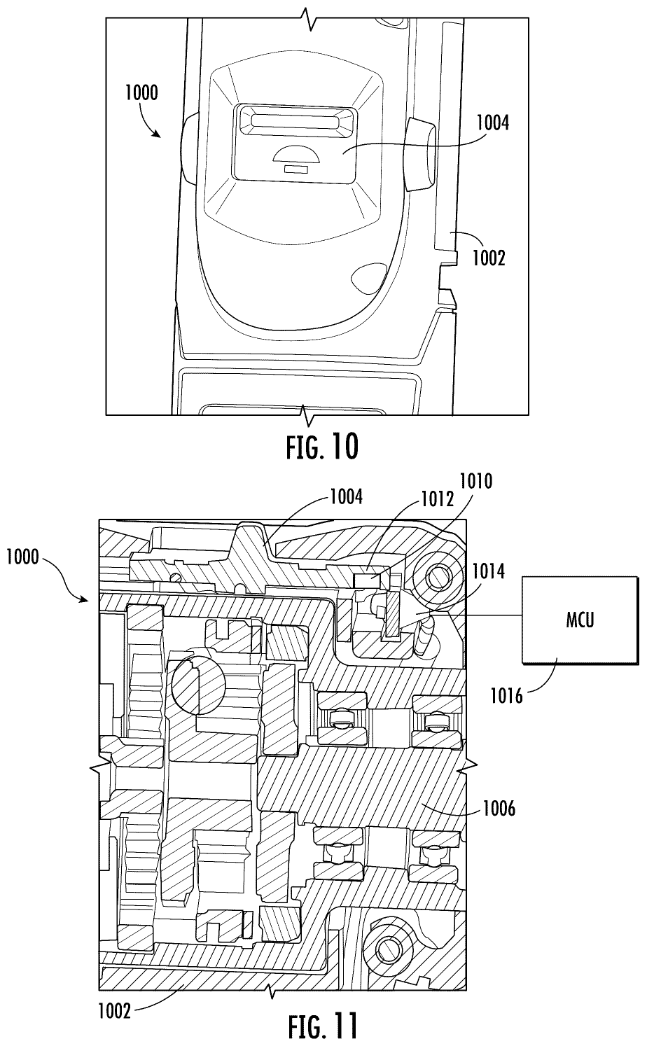

Referring to FIGS. 10 and 11, an electromechanical mode selector 1000 for pruning shears 1002 is illustrated. As shown, the mode selector 1000 includes a mechanical selector switch 1004 that mechanically switches a gear box 1006 within the pruning shears 1002. The mechanical selector switch 1004 may be used to switch between planetary gear stages of the gear box 1006, e.g., between a high speed and a low speed. Further, the mechanical selector switch 1004 may also set the desired cut capacity, e.g., 1.25″ maximum branch size versus 0.625″ maximum branch size. The mechanical selector switch 1004 may include a magnet 1010 disposed on an end 1012 of the mechanical selector switch 1004. A hall sensor 1014 may be placed near the mechanical selector switch 1004 within the pruning shears 1002. When the mechanical selector switch 1004 is moved forward, relative to FIG. 11, into a slow speed (higher torque), the hall sensor 1014 can sense the position of the mechanical selector switch 1004 and can transmit a signal to a motor control unit (MCU) 1016. The MCU 1016 may use the signal from the hall sensor 1014 to determine the desired cut capacity mode based on the selected speed. The magnet 1010 and hall sensor 1014 arrangement may serve as a redundant signal for the mode selection signal.

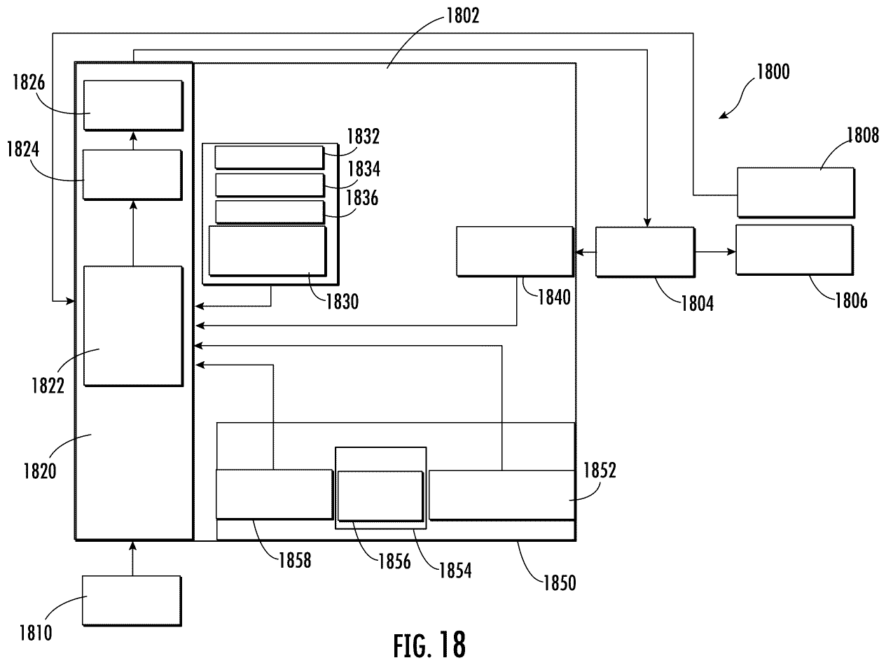

For example, for the low speed, the cut capacity may be the higher cut capacity, e.g., the cut capacity corresponding to the larger first maximum distance, D₁, described above. Conversely, when the mechanical selector switch 1004 is moved backward, relative to FIG. 11, into a high speed (lower torque), the MCU 1016 will not receive a signal from the hall sensor 1014 and the MCU 1016 may return the cut capacity mode to the lower cut capacity, e.g., the cut capacity corresponding to the smaller second maximum distance, D₂, described above. After a new speed is selected, and the trigger is pulled once, the cutting blade 144 can stop in the position corresponding to the new stopping position corresponding to the maximum open distance based on input from an inductive sensor, described below in conjunction with FIG. 18. In another embodiment, an inductive sensor or microswitch ma be used in lieu of the magnet 1010 and the hall sensor 1014.

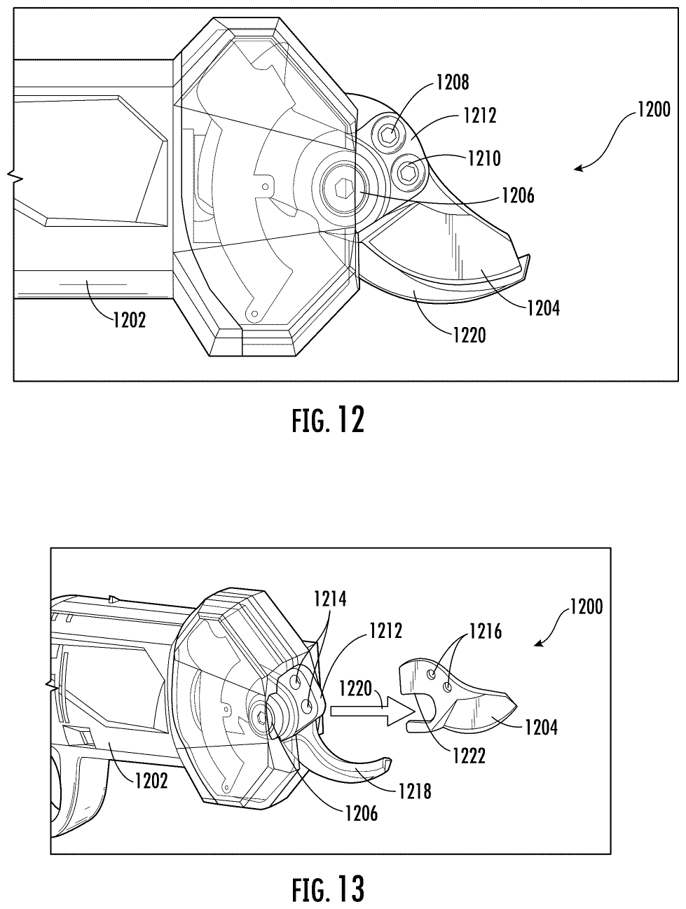

FIG. 12 and FIG. 13 illustrate a blade assembly 1200 for pruning shears 1202 and depict the removal of a cutting blade 1204 from the blade assembly 1200. To remove the cutting blade 1204 from the blade assembly 1200 and the pruning shears 1202, a locking screw 1206 may be loosened. Thereafter, a first blade screw 1208 and a second blade screw 1210 may be removed. It is to be understood that the blade screws 1208, 1210 connect the cutting blade 1204 to the arcuate rack gear 1212 that drives the motion of the cutting blade 1204. As indicated in FIG. 12 and FIG. 13, the blade screws 1208, 1210 extend through holes 1214 in the arcuate rack gear 1212 and threadably engage threaded holes 1216 formed in the cutting blade 1204.

As shown in FIG. 13, after the blade screws 1208, 1210 are removed, the cutting blade 1204 may be moved linearly away from the locking screw 1206 and the support blade 1218 of the blade assembly 1200, as indicated by arrow 1220. As shown, the cutting blade 1204 is formed with a generally U-shaped opening 1222 that is configured to fit over the shaft (not shown) of the locking screw 1206. This U-shaped opening 1222 facilitates the easy removal and replacement of the cutting blade 1204, as depicted in FIG. 12 and FIG. 13. It is to be understood that to install the cutting blade 1204 the steps, described above, may be reversed.

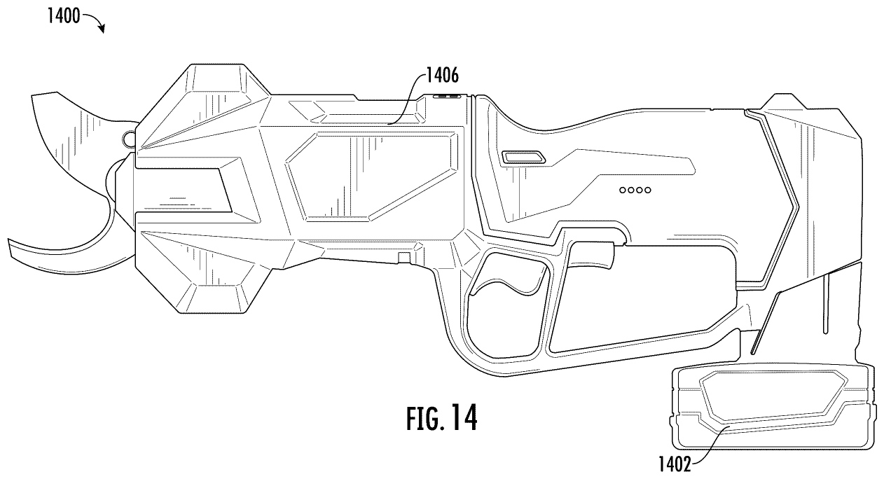

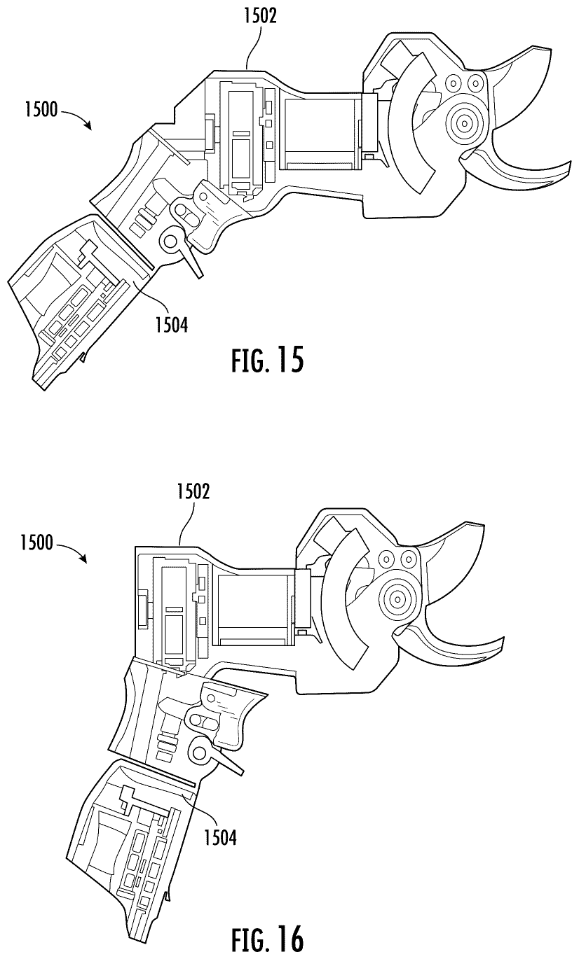

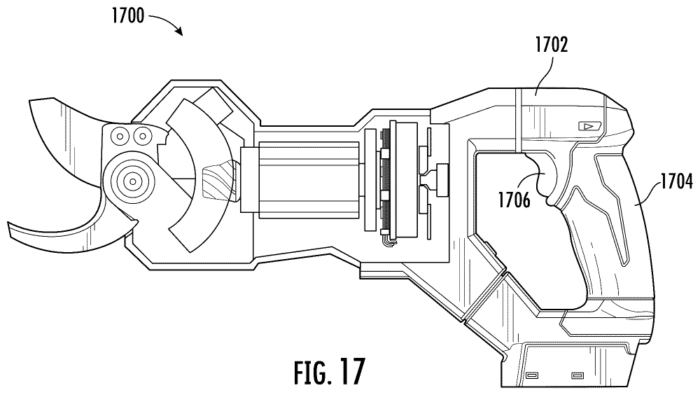

Referring briefly to FIG. 14, another embodiment of pruning shears 1400 are depicted. In this particular embodiment, the pruning shears 1400 include a larger capacity battery 1402 engaged with the housing 1406 of the pruning shears 1400. FIG. 15 and FIG. 16 depict another embodiment of pruning shears 1500. In this embodiment, the pruning shears 1500 include a first housing portion 1502 and a second housing portion 1504. The second housing portion is 1504 is pivotably connected to the first housing portion 1502 to allow the second housing portion 1504 to be rotated between a first position relative to the first housing portion 1502, as shown in FIG. 15, and a second position relative to the first housing portion 1502, as shown in FIG. 16. FIG. 17 illustrate still another embodiment of pruning shears 1700 in which the housing 1702 includes a pistol grip 1704 having a single trigger 1706.

Referring now to FIG. 18, a block diagram of pruning shears 1800 is depicted. For example, it is to be understood that the pruning shears 1800 represent any of the pruning shears 100, 1400, 1500, 1700 described herein. As illustrated, the pruning shears 1800 include a printed circuit board assembly (PCBA) 1802 electrically operatively coupled to a motor 1804 that is operatively coupled with and drives a blade assembly 1806. For example, the motor 1804 is the motor 120 described above. Further, the blade assembly 1806 is one or both of the blade assemblies 140, 1200 described herein. A sensor board 1808 is electrically operatively coupled to the PCBA 1802. The sensor board 1808 includes a plurality of hall sensors and is placed adjacent the blade assembly 1806 to sense the movement and/or the positions of at least one of the blades that make up the blade assembly 1806 using magnets placed on at least one of the blades. As shown, a battery pack 1810 is also operably coupled to the PCBA 1802. It is to be understood that the battery pack 1810 is removably engaged with the pruning shears 1800.

FIG. 18 shows that the PCBA 1802 includes a control board 1820 that includes a motor control unit (MCU) 1822, a gate driver 1824 operatively coupled to the MCU 1822, and a plurality of power metal-oxide-semiconductor field-effect transistors 1826 (MOSFETs) operatively coupled to the gate driver 1824. The power MOSFETS 1826 are also electrically operatively coupled to the motor 1804 and are used to control the movement of the motor 1804. The PCBA 1802 also includes a motor hall board 1840 adjacent the motor 1804 and electrically operably coupled to the control board 1820. The motor hall board 1840 includes a plurality of hall sensors configured to detect one or more magnets on the motor 1804 to detect a speed of the motor 1804, a direction of rotation of the motor 1804, a position of the motor 1804, a distance to a desired position of the motor 1804, or a combination thereof.

As further illustrated, the PCBA 1802 includes a user interface board 1830 that is electrically operably coupled to the control board 1820. The user interface board 1830 includes a mode indicator 1832, a power on/off indicator 1834, and a battery indicator 1836. The mode indicator 1832 indicates the mode in which the pruning shears 1800 are operating. In one aspect, the mode is based on the cutting speed of the pruning shears 1800. In another aspect, the mode is based on the cut capacity of the pruning shears 1800. The power on/off indicator 1834 indicates whether the pruning shears 1800 are powered on or off. Moreover, the battery indicator 1836 indicates the remaining battery level for the removable battery 1810 when it is engaged with the pruning shears 1800.

FIG. 18 shows that the PCBA 1802 includes a trigger assembly 1850 disposed thereon. The trigger assembly 1850 is used to control the operation of the motor 1804 and includes a trigger potentiometer 1852 electrically operably coupled to the control board 1820. The trigger assembly 1850 also includes a trigger 1854 mechanically operably coupled to the trigger potentiometer 1852. The trigger 1854 includes a magnet 1856 engaged with, or otherwise disposed on the trigger 1854. A trigger hall board 1858 is placed adjacent the trigger 1854. The trigger hall board 1858 includes one or more hall sensor configured to sense the magnet 1856 and detect movement of the magnet 1856 and the trigger 1854. During operation of the pruning shears 1800, the trigger 1854 is pressed, or otherwise toggled, to activate the motor 1804. Specifically, as the trigger 1854 is pressed, the trigger potentiometer 1852 sends a voltage signal, which is indicative as to the distance that the trigger 1854 is pressed, to the MCU 1822 within the control board 1820. The voltage from the trigger potentiometer 1852 is the primary signal. The MCU 1822, in turn, sends a signal to the motor hall board 1840 to activate, or otherwise operate, the motor 1804 at a speed that corresponds to the amount in which the trigger 1854 is pulled. The motor 1804 then drives the blade assembly 1806. At the same time, while the trigger 1854 is pressed, or otherwise toggled, the movement of the magnet 1856 on the trigger 1854 (and by extension, the movement of the trigger 1854) is detected by the trigger hall board 1858. The trigger hall board 1858 sends a redundant signal to activate the motor 1804 at a speed that corresponds to the distance in which the trigger 1854 is pressed. The motor 1804 then drives the blade assembly 1806.

It is to be understood that the MCU 1822 is operable to execute, or otherwise perform, one, more, all, or any combination of the method steps described below in conjunction with the methods 1900, 2000, 2200 described below. For example, the MCU 1822 is operable to receive at least one trigger potentiometer voltage signal from the trigger potentiometer 1852, receive at least one trigger hall sensor voltage signal from the trigger hall board, and at least partially based on the at least one trigger potentiometer voltage signal and the at least one trigger hall sensor voltage signal, operating the motor 1804.

It is to be understood that the trigger potentiometer 1852 is a primary trigger movement detector that detects movement of the trigger 1854, e.g. a distance that the trigger is pressed and the return of the trigger 1854 to an off position. It is further to be understood that the magnet 1856 and the trigger hall board 1858 are a redundant, or secondary, trigger movement detector that detects movement of the trigger 1854, e.g. a distance that the trigger is pressed and the return of the trigger 1854 to an off position. In another aspect, the magnet 1856 and the trigger hall board 1858 are the primary trigger movement detector and the trigger potentiometer 1852 is the redundant, or secondary, trigger movement detector.

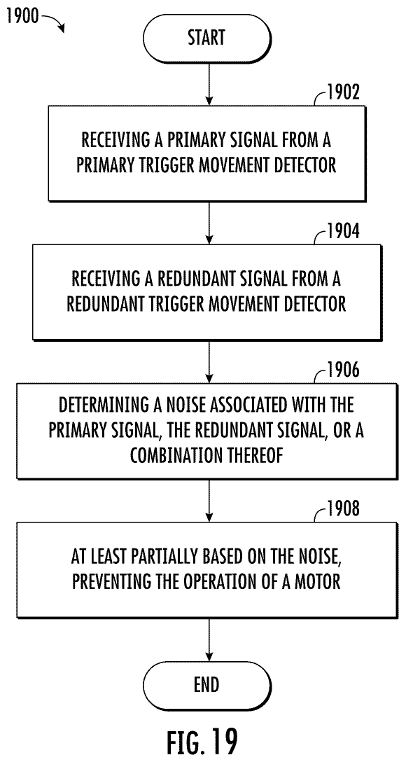

FIG. 19 depicts a method of operating pruning shears. The method 1900 begins at block 1902 and includes receiving a primary signal from a primary trigger movement detector. In one aspect, the primary trigger movement detector is a trigger potentiometer that detects movement of a trigger coupled thereof. In another aspect, the primary trigger movement detector is a magnet coupled to a trigger and a trigger hall board that detects movement of the magnet and the trigger coupled thereto. At block 1904, the method 1900 includes receiving a redundant signal from a redundant trigger movement detector. In one aspect, the redundant trigger movement detector is a magnet coupled to a trigger and a trigger hall board that detects movement of the magnet and the trigger coupled thereto. In another aspect, the redundant trigger movement detector is a trigger potentiometer that detects movement of a trigger coupled thereof. It is to be understood that the primary trigger movement detector is different from the redundant trigger movement detector.

Continuing the description of the method 1900, at block 1906, the method 1900 includes determining a noise associated with the primary signal, the redundant signal, or a combination thereof. Further, at block 1908, the method 1900 includes at least partially based on the noise, preventing the operation of a motor. Thereafter, the method 1900 ends.

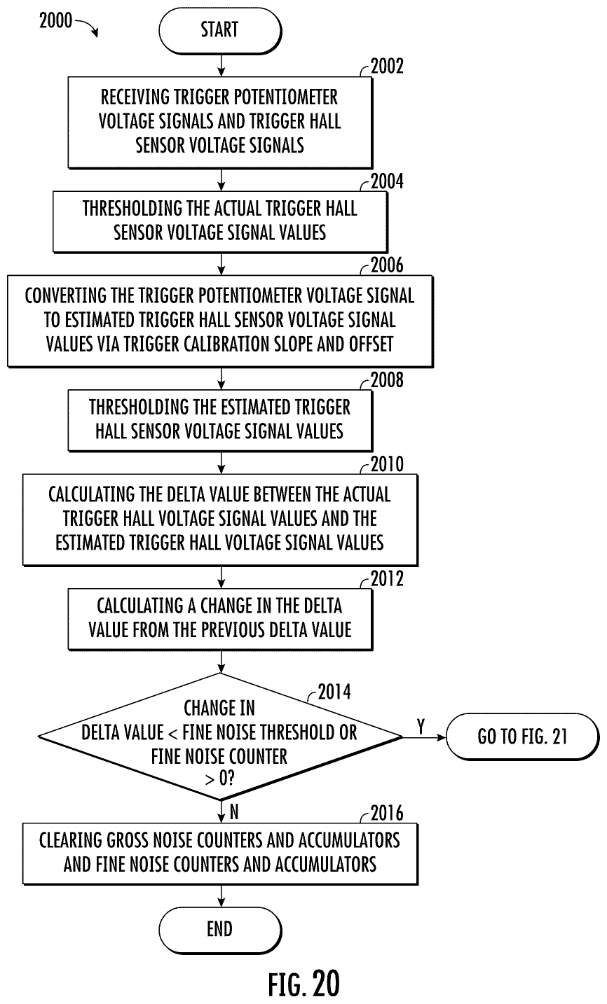

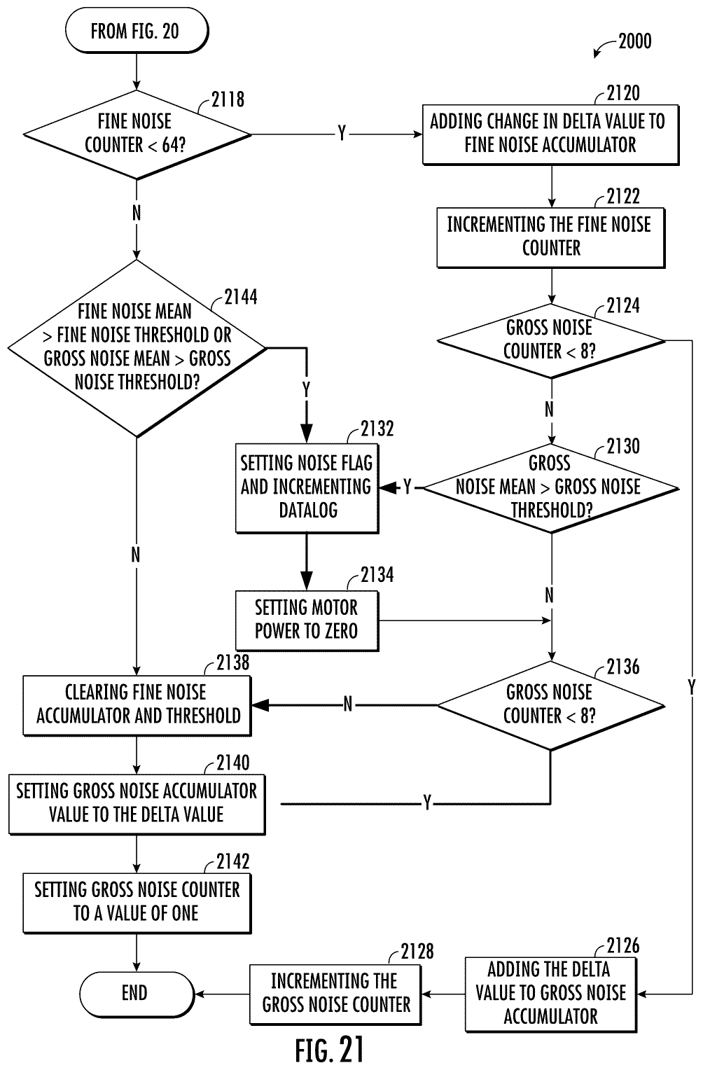

Referring to FIGS. 20-21, a method of detecting trigger noise in pruning shears, e.g., any of the pruning shears 100, 1400, 1500, 1700, 1800, described herein is illustrated and is designated 2000. It is to be understood that one or more of the method 2000 steps described below are performed at a control board within the pruning shears. Commencing at block 2002, the method 2000 includes receiving actual trigger potentiometer signals and actual trigger hall sensor signals. The actual trigger potentiometer signals and actual trigger hall sensor signals are received at the control board when a trigger of the pruning shears is toggled, or otherwise, pressed by a user.

At block 2004, the method 2000 includes thresholding the actual trigger hall sensor signals. It is to be understood that thresholding the actual trigger hall sensor signals is selectively performed. In other words, this step is optional and only occurs when the actual trigger hall sensor signals are less than a predetermined trigger hall signal threshold value and in such a case, the actual trigger hall sensor signals are set equal to the trigger hall signal threshold value. Moving to block 2006, the method 2000 includes converting actual potentiometer signals to estimated trigger hall sensor signals using a trigger calibration slope graph and a predetermined offset value. At block 2008, the method 2000 includes thresholding the estimated trigger hall sensor signals. It is to be understood that thresholding the estimated trigger hall sensor signals is selectively performed. In other words, this step is optional and only occurs when the estimated hall sensor signals are less than a predetermined trigger hall sensor threshold value and in such a case the estimated trigger hall sensor signals are set equal to the threshold trigger hall sensor value.

Moving to block 2010, the method 2000 includes calculating a delta value between the actual trigger hall signal values and the estimated trigger hall signal values. Further, at block 2012, the method 2000 includes calculating a change in the delta value from the previous delta value. Thereafter, at decision 2014, the method 2000 includes determining whether the change in the delta value is less than a fine noise threshold or whether a fine noise counter is greater than zero. If either the change in the delta value is greater than the fine noise threshold or the fine noise counter is less than zero, the method 2000 proceeds to block 2016 where the method 2000 includes clearing the gross noise counters and accumulators and clearing the fine noise counters and accumulators. Thereafter, the method 2000 ends.

Returning to decision 2014, if the change in the delta value is less than the fine noise threshold or the fine noise counter is greater than zero, the method 2000 proceeds to decision 2118 of FIG. 21. At decision step 2118, the method 2000 includes determining whether a fine noise counter is less than sixty-four (64). If the fine noise counter is less than sixty-four (64), the method 2000 proceeds to block 2120 where the method 2000 includes adding the change in the delta value to fine noise accumulator. Thereafter at block 2122, the method 2000 includes incrementing the fine noise counter. For example, the fine noise counter is incremented by a value of one (1).

Moving to decision 2124, method 2000 includes determining whether a gross noise counter is less than eight (8). If the gross noise counter is less than eight (8), the method 2000 proceeds to block 2126 and the method 2000 includes adding the delta value to the gross noise accumulator. Thereafter, at block 2128, the method 2000 includes incrementing the gross noise counter. For example, the gross noise counter is incremented by a value of one (1). From block 2128, the method 2000 ends.

Returning to decision 2124, if the gross noise counter is not less than eight (8), the method 2000 moves to decision 2130 and includes determining whether the gross noise mean is greater than a gross noise threshold. If the gross noise mean is greater than the gross noise threshold, the method 2000 proceeds to block 2132 and includes setting a noise flag and incrementing a data log. For example. The noise flag is set to “TRUE” indicating that substantial noise exists. From block 2132, the method 2000 continues to block 2134 and includes setting a motor power to zero. Thereafter, the method 2000 proceeds to decision 2136.

Returning to decision 2130, if the gross noise mean is not greater than the gross noise threshold, the method 2000 also proceeds to decision 2136. At decision 2136, the method 2000, once again, includes determining whether a gross noise counter is less than eight (8). If the gross noise counter is not less than eight (8), the method 2000 proceeds to block 2138 and includes clearing the fine noise accumulator and threshold. Then, at block 2140, the method 2000 includes setting the gross noise accumulator value to the delta value. Moving to block 2142, the method 2000 includes setting the gross noise counter to a value of one. The method 2000 then ends. Returning to decision 2136, if the gross noise counter is less than eight (8), the method 2000 proceeds directly to block 2140 and continues as described herein.

Returning to decision 2118, if the fine noise counter is not less than sixty-four (64), the method 2000 proceeds to decision 2144. At decision 2144 the method 2000 includes determining whether a fine noise mean is greater than a fine noise threshold or whether a gross noise mean is greater than a gross noise threshold. If the fine noise mean is greater than the fine noise threshold, or the gross noise mean is greater than the gross noise threshold, the method proceeds to block 2132 and continues as previously described. On the other hand, if the fine noise mean is not greater than the fine noise threshold, or the gross noise mean is not greater than the gross noise threshold, the method 2000 moves to block 2138 and continues as previously described.

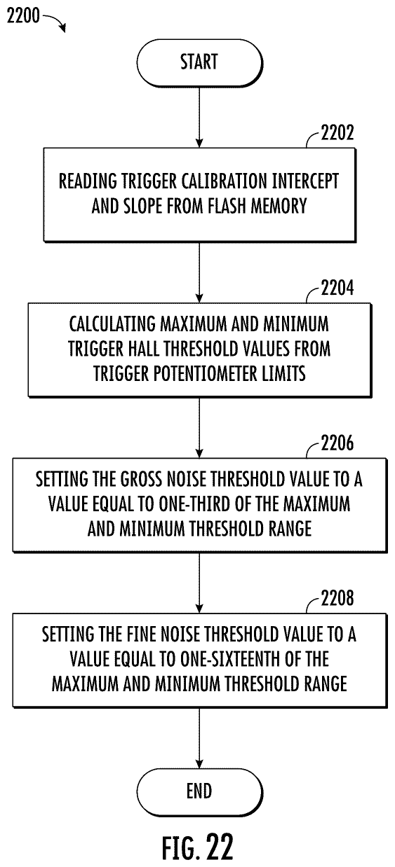

Referring to FIG. 22, a method of initializing variables for trigger noise detection in pruning shears is illustrated and is generally designated 2200. It is to be understood that the method 2200 is used with any of the pruning shears 100, 1400, 1500, 1700, 1800, described herein. It is to be further understood that one or more of the method 2200 steps described below are performed at a control board within the pruning shears.

Beginning at block 2202, the method 2200 includes reading a trigger calibration intercept and slope from a flash memory within the pruning shears. At block 2204, the method 2200 includes calculating maximum and minimum trigger hall threshold values from trigger potentiometer limits. Next, at block 2206, the method 2200 includes setting a gross noise threshold value to a value equal to one-third of the maximum and minimum threshold range determined at step 2204. Moreover, at block 2208, the method 2200 includes setting a fine noise threshold value to a value equal to one-sixteenth of the maximum and minimum threshold range determined at step 2204. The method 2200 then ends. It is to be understood that, in certain instances, the method 2200 is performed prior to the method 2000 shown and described in conjunction with FIGS. 20-21.

Although the invention has been described in detail with reference to certain preferred embodiments, variations and modifications exist within the scope and spirit of one or more independent aspects of the invention as described.

Various features of the invention are set forth in the following claims.

What is claimed is:

1. Pruning shears, comprising:
a housing comprising
a motor portion;
a handle portion;
a motor disposed within the motor portion of the housing;
a motor control unit operably coupled to the motor; and
a trigger assembly disposed within the handle portion and operably coupled to the motor control unit to control the motor, wherein the trigger assembly includes
a trigger;
a primary trigger movement detector; and
a redundant trigger movement detector, wherein the primary trigger movement detector and the redundant trigger movement detector each sense movement of the trigger when the trigger is pressed and send signals to the motor control unit to control operation of the motor.

2. The pruning shears of claim 1, wherein the primary trigger movement detector comprises a trigger potentiometer coupled to the trigger.

3. The pruning shears of claim 2, wherein the trigger potentiometer transmits a primary signal indicative of a distance that the trigger is pressed based on a movement of the trigger potentiometer.

4. The pruning shears of claim 3, wherein the motor control unit sends a primary signal to the motor to set a speed of the motor based on the distance that the trigger moves detected by the trigger potentiometer.

5. The pruning shears of claim 1, wherein the redundant trigger movement detector comprises a magnet disposed on the trigger and a trigger hall board adjacent the trigger to sense movement of the magnet.

6. The pruning shears of claim 5, wherein the trigger hall board transmits a redundant signal indicative of a distance that the trigger is pressed based on movement of the magnet sensed by the trigger hall board.

7. The pruning shears of claim 6, wherein the motor control unit sends a redundant signal to the motor to set a speed of the motor based on the distance that the trigger moves detected by the trigger hall board.

8. A method of operating pruning shears, the method comprising:
receiving a primary signal from a primary trigger movement detector;
receiving a redundant signal from a redundant trigger movement detector;
determining a noise associated with the primary signal, the redundant signal, or a combination thereof; and
at least partially based on the noise, preventing the operation of a motor.

9. The method of claim 8, wherein the primary trigger movement detector detects movement of a trigger within a trigger assembly and the primary signal represents the movement of the trigger.

10. The method of claim 8, wherein the redundant trigger movement detector detects movement of the trigger and the redundant signal represents the movement of the trigger.

11. The method of claim 8, wherein the primary trigger movement detector is different from the redundant trigger movement detector.

12. The method of claim 11, wherein the primary trigger movement detector comprises a trigger potentiometer coupled to a trigger.

13. The method of claim 12, wherein the redundant trigger movement detector comprises a magnet disposed on the trigger and a trigger hall board adjacent the magnet.

14. Pruning shears, comprising:
a housing comprising
a motor portion;
a handle portion;
a motor disposed within the motor portion of the housing;
a trigger assembly disposed within the handle portion and operably coupled to the motor, wherein the trigger assembly includes
a trigger;
a trigger potentiometer coupled to the trigger;
a magnet disposed on the trigger; and
a trigger hall board adjacent the magnet; and
a motor control unit operably coupled to the motor and the trigger assembly, wherein the motor control unit is operable to receive at least one trigger potentiometer voltage signal from the trigger potentiometer;
receive at least one trigger hall sensor voltage signal from the trigger hall board; and
at least partially based on the at least one trigger potentiometer voltage signal and the at least one trigger hall sensor voltage signal, operating the motor.

15. The pruning shears of claim 14, wherein the motor control unit is further operable to selectively threshold the at least one trigger hall sensor voltage signal.

16. The pruning shears of claim 15, wherein the motor control unit is further operable to convert the at least one trigger potentiometer voltage signal to at least one estimated hall voltage signal value.

17. The pruning shears of claim 16, wherein the motor control unit is further operable to selectively threshold the at least one estimated trigger hall sensor voltage value.

18. The pruning shears of claim 17, wherein the motor control unit is further operable to calculate a delta value between the at least one trigger hall sensor voltage value and the at least one estimated trigger hall sensor voltage value.

19. The pruning shears of claim 18, wherein the motor control unit is further operable to calculate a change in the delta value from the previous delta value.

20. The pruning shears of claim 19, wherein the motor control unit is further operable to use the change in the delta value to determine a noise associated with the at least one trigger hall sensor voltage value and set a motor power to zero when the noise is greater than a threshold.
